(19) United States
(12) Patent Application Publication
(10) Pub. No.: US 2009/0120284 A1
(43) Pub. Date: May 14, 2009

(54) REDUCING POLLUTANT DISCHARGE FROM GASOLINE STORAGE TANKS

(76) Inventor: Rodger P. Grantham, Springfield, MO (US)

Correspondence Address: STEVENS & SHOWALTER LLP, 7019 CORPORATE WAY, DAYTON, OH, 45459-4238, US

(21) Appl. No.: 12/262,220

(22) Filed: Oct. 31, 2008

Related U.S. Application Data
(60) Provisional application No. 60/985,040, filed on Nov. 2, 2007.

(51) Int. Cl. B01D 53/04; B01D 53/047; B01D 53/30

(52) U.S. Cl. 95/11; 96/143; 96/115; 96/114; 96/111; 96/117; 96/146; 95/143; 95/19; 95/96

(57) ABSTRACT

An active adsorbent pollutant reducing system includes a canister containing activated carbon, a pump and a series of valves connected to the canister and the pump. The valves and pump of the system are controlled so that vapor/air in the ullage of a gasoline storage tank is pumped to the canister/adsorbent material when tank pressure reaches a first level with vapor being adsorbed and air being discharged to atmosphere. When a second tank pressure level, lower than the first tank pressure level, is achieved, the valves are controlled to reconfigure the pump and canister so that continued pump operation pulls a vacuum on the canister resulting in adsorbed gasoline vapor being purged from the adsorbent material and returned to the storage tank. Tank pressure, HC content in the vapor flow and canister weight can be used for control of the system.

### CROSS REFERENCE TO RELATED APPLICATIONS

This application claims the benefit of U.S. Provisional Patent Application No. 60/985,040 filed Nov. 2, 2007, and entitled REDUCING POLLUTANT DISCHARGE FROM GASOLINE STORAGE TANKS which is incorporated herein by reference in its entirety.

### BACKGROUND OF THE INVENTION

The present invention generally relates to a system for reducing the discharge of pollutants from gasoline storage tanks, typically installed underground, at gasoline distribution facilities (GDFs). More particularly, an active adsorption system discharges non-pollutant air from an associated gasoline tank when the pressure within the tank reaches a predetermined level. Non-pollutant air is separated from a gasoline vapor/air mixture by passage through a container holding an adsorbent material. An electric pump and a network of electrically operated valves connected to the pump and the container are controlled so that non-pollutant air is discharged to the atmosphere and gasoline vapors are retained and recovered into the tank. The system can be controlled in response to pressure within the tank, the level of hydrocarbons in the vapor/air mixture and/or the weight of the adsorbent material within the container.

Pollutant discharge reduction systems are well known and used to reduce pressure that can otherwise buildup within a gasoline storage tank, such as an underground storage tank (UST), without polluting the atmosphere. One variety of known systems uses membranes for the reduction or retention of pollutants. These systems pass the vapor/air mixture from the ullage of a gasoline storage tank through membranes that retain gasoline vapor pollutants within the systems but pass non-pollutant air which is then vented to atmosphere. Membrane systems are exemplified by U.S. Pat. Nos. 5,464,466; 5,571,310; 5,985,002; 6,293,996; and 6,608,484, which are all incorporated by reference herein.

Other systems use adsorbent material, such as activated carbon, to reduce the discharge of pollutants from gasoline storage tanks. Known adsorbent systems used for gasoline storage tanks are passive in that they adsorb and de-adsorb pollutant vapors for associated storage tanks by using storage tank pressure differentials relative to atmospheric pressure to vent out from the storage tank to atmosphere, and vent into the storage tank from atmosphere. Thus, when pressure inside a storage tank increases due to an increase in vapor, the vapor is adsorbed by an appropriate material in a container or canister that is sized to accommodate the associated storage tank. Underground storage tanks (USTs) tend to pressurize during periods of inactivity, such as during the night or when an associated GDF is closed, so that a passive system needs to be sized to be able to adsorb all of the vapor that needs to be collected during this segment of a twenty four hour period.

A passive adsorption system relies on the interaction of onboard refueling vapor recovery (ORVR) compatible vapor recovery systems that are present in GDFs, such as a Balance system commercially available from Vapor Systems Technologies, Inc., the assignee of the present application, to purge the canister daily of the adsorbed vapor. Due to the interaction of the vapor recovery system and ORVR equipped vehicles, no air or vapor is returned to the UST during a vehicle refueling, which tends to reduce the pressure in the UST, typically to a vacuum level. The passive system relies on the tank vacuum to draw air back through the canister and into the UST. The airflow back through the canister tends to de-adsorb the vapor from the adsorbent material.

One drawback to the way that the passive system de-adsorbs vapor from the system is that the air ingestion into the tank during de-adsorption will itself tend to create vapor growth and re-pressurization of the UST. Another negative aspect of the passive system is that it is only applicable to regions that have vehicles with ORVR, such as in the United States, since the passive system relies on the interaction of the vapor recovery system with ORVR equipped vehicles to allow for canister purging.

### SUMMARY OF THE INVENTION

The active adsorbent pollutant reducing system of the present invention comprises a container or canister that holds an adsorbent material, such as activated carbon, a pump and a series of valves that are connected to the canister and the pump. The valves and pump are controlled so that a vapor/air mixture in the ullage of an associated gasoline storage tank is pumped to the canister for evacuation of non-pollutant air from the tank. During evacuation, the vapor is adsorbed by the adsorbent material in the canister and non-pollutant air which passes through the canister is discharged to atmosphere. Once an amount of non-pollutant air has been removed from the tank and discharged to atmosphere, the valves are reconfigured around the pump so that a vacuum is drawn on the canister to pump adsorbed vapor back to the tank. The system can be activated in response to pressure within the tank reaching a first level, reconfigured in response to the pressure in the tank reaching a second level and deactivated after vapor within the adsorbent material in the canister has been removed, purged or de-adsorbed from the adsorbent material so that the system can once again be used for evacuation. When tank pressure is the control parameter, a pressure transducer or sensor monitors the pressure in the tank. The system can also be controlled based on the hydrocarbon level within vapor/air streams passing through the system and/or the weight of the adsorbent material as vapor is adsorbed by and removed from the adsorbent material.

### BRIEF DESCRIPTION OF THE SEVERAL VIEWS OF THE DRAWINGS

The following detailed description of various embodiments of the present invention can best be understood when read in conjunction with the following drawings, where like structure is indicated with like reference numerals, and in which:

FIG. 1 is a schematic diagram of a system for reducing the discharge of pollutants from gasoline storage tanks in accordance with the present invention;

FIG. 2 is a schematic diagram of the system of FIG. 1 configured for an evacuation operating state;

FIG. 3 is a schematic diagram of the system of FIG. 1 configured for a purge operating state;

FIG. 4 is a schematic diagram of a system for reducing the discharge of pollutants from gasoline storage tanks in accordance with the present invention including a hydrocarbon (HC) sensor for possible control of the system;

FIG. 5 is a schematic diagram of the system of FIG. 4 configured for an evacuation operating state; and

FIG. 6 is a schematic diagram of the system of FIG. 4 configured for a purge operating state.

### DETAILED DESCRIPTION OF THE INVENTION

In the detailed description, reference is made to the accompanying drawings that form a part hereof, and in which is shown by way of illustration, and not by way of limitation, specific embodiments in which the invention may be practiced. It is to be understood that other embodiments may be utilized and that changes may be made without departing from the spirit and scope of various embodiments of the present invention.

The operating cycle of an active adsorbent pollutant reducing system of the present invention comprises an inactive portion and an active or run portion. The run portion of the operating cycle of the system comprises two states: an evacuation state during which gasoline vapor is adsorbed in a canister and non-pollutant air is evacuated from an associated storage tank; and a purge state during which gasoline vapor is de-adsorbed or purged from the canister and returned to the tank. Embodiments of active adsorbent pollutant reducing systems of the present application will now be described with reference to the drawing figures.

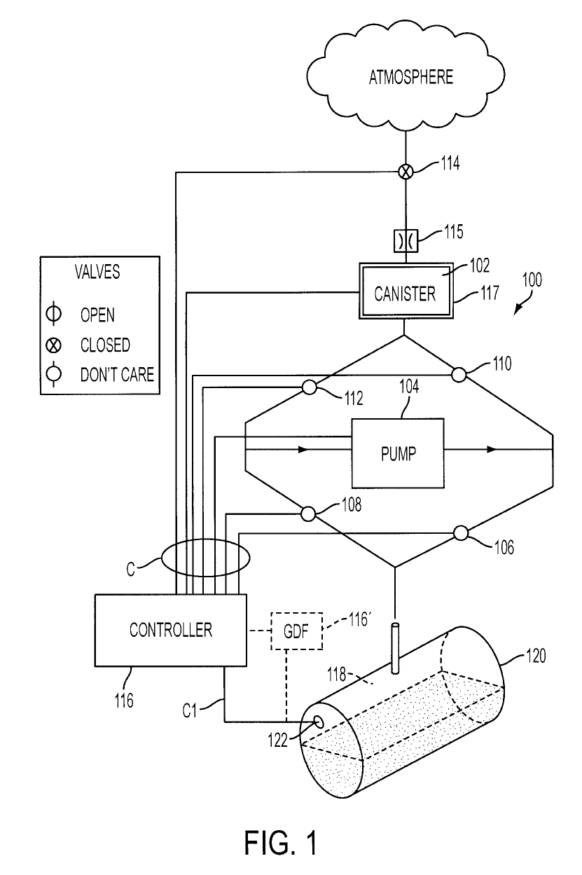

The schematically illustrated system 100 shown in FIG. 1 comprises an adsorbent material containing structure referred to as a container or canister 102, a pump 104 and a series of valves 106, 108, 110, 112, 114 that are connected to the canister 102 and the pump 104 as shown. In a working embodiment of the invention, the canister had a capacity of about 0.2 cubic feet and contained activated carbon. The valves 106, 108, 110, 112, 114 can each be a single acting valve, two three way valves (for example valve pairs 106, 108 and 110, 112 or valve pairs 106, 110 and 108, 112 can be three way valves) and one single acting valve (114), an integral valve manifold or any other valving arrangement that will perform the required fluid valving required for operation of the system 100 as described below and illustrated by the drawing figures.

The valves 106, 108, 110, 112, 114 and pump 104 of the system are controlled, for example, by a controller 116, via connections C to the controller 116. The controller 116, for example, can be a stand-alone controller for the active adsorbent pollutant reducing system 100, can be the controller of a gasoline distribution facility (GDF) using the system 100 or can be a controller dedicated to the system 100 that shares control of the system with another controller, for example the controller 116′ of a GDF, see FIG. 1.

Optionally, a restrictor 115 may be placed on the end of the canister 102 that is connected to atmosphere through the valve 114 to increase the pressure in the canister 102 during one or more operating states of the system 100 as will be described below. Increasing the pressure in the canister 102 will increase the capacity of the adsorbent. Additionally, a thermal device, for example, a heating blanket 117 may be associated with the canister 102 to provide heat to the canister 102 during one or more operating states of the system 100. Increasing the temperature of the adsorbent may increase the capacity of the adsorbent, or can be used to assist de-adsorbtion.

As shown in FIG. 1 when the system 100 is in the inactive portion of its operating cycle, the pump 104 is not operating and the valve 114 is closed. The remaining valves 106, 108, 110, 112 can be either open or closed (don't care); however, the state of the valves 106, 108, 110, 112 can depend on the implementation of the valves as will be apparent to those skilled in the art. In the inactive state, the system 100 is effectively a closed passage extending from the ullage 118 of an associated tank 120, typically one or more underground storage tank (UST), potentially to the valve 114.

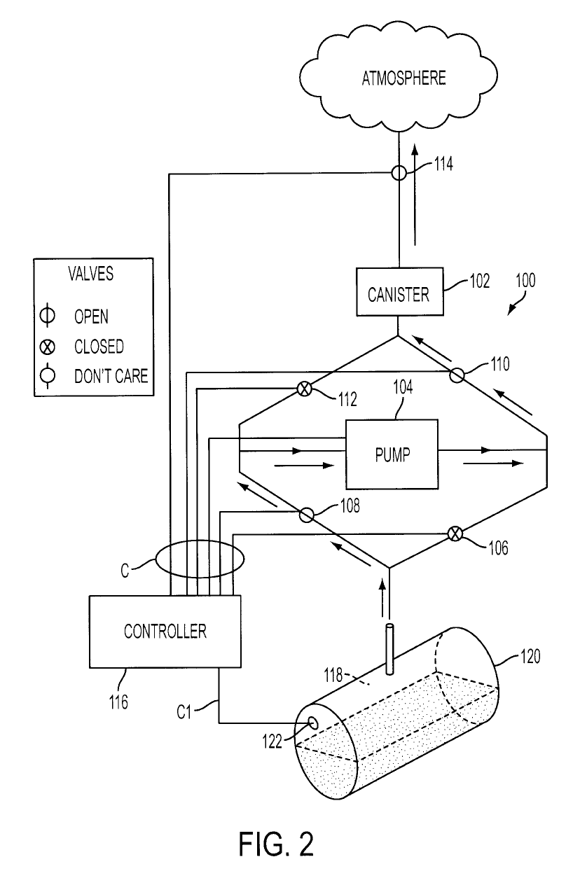

The pressure within the ullage 118 of the tank 120 can be monitored by a pressure sensor 122 which is connected to the controller 116 via a connection C1. In one control arrangement, the pressure in the ullage 118 of the tank 120 can be monitored by the GDF controller 116′ with the pressure measurements being used for general operation of the GDF, for example for diagnostics of GDF operation, and also for operation of the system 100. In that case, the controller 116 of the system 100 can be the GDF controller 116′ or the controller 116 can work with the GDF controller 116′ as suggested in FIG. 1. In any event, when the system 100 is not active and the pressure in the ullage 118 of the tank 120 exceeds a first pressure level (a tank pressure of +0.2 inches of water was used in a working embodiment, however, other pressure levels are contemplated for use in the system 100 of the present application), the system is activated by closing the passages associated with valves 106 and 112, opening the passages associated with valves 108, 110 and 114, and turning on the pump 104, see FIG. 2.

For the state of the system shown in FIG. 2, referred to as the evacuation state, a gaseous vapor/air mixture is pumped from the ullage 118 of the tank 120 through the canister 102, as shown by arrows, so that gasoline vapor is adsorbed by the adsorbent material in the canister 102. When the system 100 is in the evacuation state, gasoline vapor is adsorbed by the adsorbent material in the canister 102 and non-pollutant air is discharged through the valve 114 to atmosphere. The pump 104 continues to pump the vapor/air mixture as shown in FIG. 2 until a second pressure level, lower than the first pressure level, is achieved in the tank 120 (a pressure of −1.0 inches of water was used in a working embodiment, however, other pressure levels are contemplated for use in the system 100 of the present application).

It is noted that increased pressure within the canister 102, provided, for example, by the restrictor 115 as described above and shown in FIG. 1, may increase the capacity of the adsorbent material in the canister 102 and may also improve the adsorption efficiency of the adsorbent material to increase the capacity of the system 100.

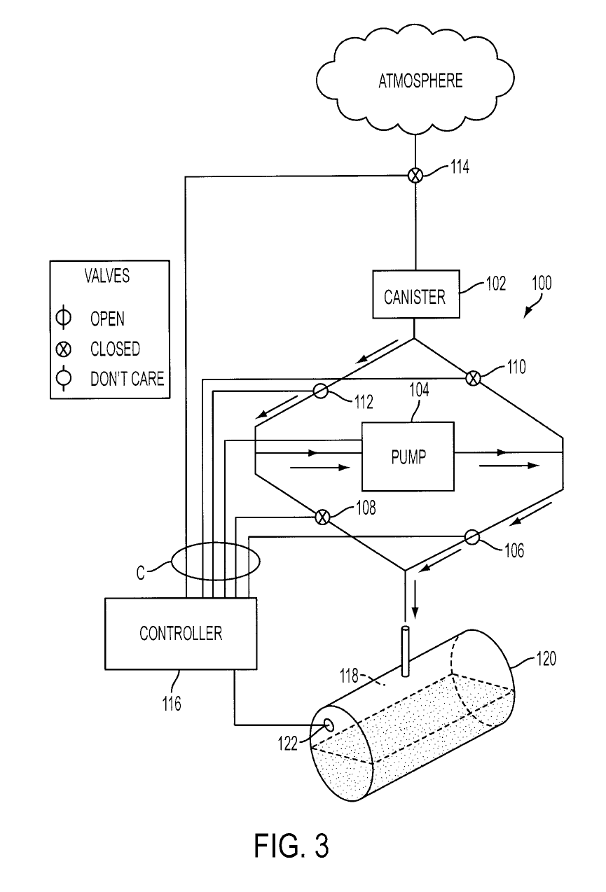

When the second pressure level is achieved in the tank 120, the valves 106, 108, 110, 112, 114 are controlled to reconfigure the passage from the canister 102 through the pump 104 to what is referred to as the purge state of the system 100, see FIG. 3. In the purge state, operation of the pump 104 pulls a vacuum on the adsorbent material in the canister 102 resulting in gasoline vapor that has been adsorbed being removed, de-adsorbed or purged from the adsorbent material and returned to the storage tank 120 as shown by the arrows in FIG. 3. More particularly, the passages associated with valves 106 and 112 are opened, and the passages associated with valves 108, 110 and 114 are closed. To best prepare the system 100 for the next evacuation operation, the purge state is maintained for a sufficient period of time to remove all or substantially all the gasoline vapor from the adsorbent material in the canister 102.

It is noted that increased temperature within the canister 102, provided, for example, by the thermal blanket 117 as described above and shown in FIG. 1, may increase the rate of purging or de-adsorption of vapor from the adsorbent material in the canister 102 to increase the capacity of the system 100.

The time period for purge state operation of the system 100 can be determined in a number of ways. One control strategy is to maintain the purge state for a period of time sufficient to remove substantially all gasoline vapor from the adsorbent material presuming that the adsorbent material is saturated with vapor. For example, a purge time period of 15 minutes was found to perform satisfactorily in a working embodiment under what is anticipated to be substantially worst case conditions at the GDF. However, this strategy tends to operate the pump 104 for longer time periods than are often required to adequately purge the canister 102. Accordingly, to extend the life of the pump 104 and the system 100 overall, it is possible to operate the pump 104 only for the time necessary to adequately purge the adsorbent material in the canister 102 for operation once again in the evacuate state.

One way of determining an appropriate time period for operation of the system 100 in the purge state is to monitor the time that the system 100 is operated in the evacuation state during which it is sending vapor to the canister 102. When operation in the evacuation state is terminated, the elapsed run time in the evacuation state can be used to determine a corresponding operating time for the system in the purge state. For example, an appropriate factor can be used to multiply the evacuation operating time, Tₑ, by a factor X so that the purge time Tₚ would be equal to X·Tₑ, Tₚ=X·Tₑ. In a working embodiment of the system 100, the factor was set to 15, however, the actual factor for a given system would depend on a number of variables including, for example, the size and amount of adsorbent material in the canister 102 and the flow rate of the gaseous vapor/air mixture. Accordingly, the factor or the correspondence of purge time to evacuate time can vary dependent of a given application and installation of the system 100.

If the restrictor 115 is used in the system 100, the increased pressure within the canister 102 improves vapor adsorption by the adsorbent material in the canister 102. Vapor purging improvement can be provided by heating the canister 102, for example by means of the optional heating blanket 117 shown in FIG. 1. Added heat improves purging by increasing the rate of vapor removal from the adsorbent material in the canister 102. Thus, use of either or both of the optional restrictor 115 and the optional heating blanket 117 get the adsorbent material cleaner and/or reduce the amount of time needed to purge the canister 102 for operation in the next evacuation state. Since the capacity of the system 100 is primarily determined by the time needed to purge vapor from the adsorbent material in the canister 102, shortening the purge time increases the capacity of the system 100.

In a time control arrangement for the evacuation state of the active portion of the operating cycle of the system 100, when the pressure in the tank 120 exceeds the first pressure level, e.g., a tank pressure of about +0.2 inches of water, the system 100 is activated to operate in the evacuation state for a given period of time. However, after operation in the evacuation state for a maximum predetermined amount of time, for example 1 minute, the system 100 ceases to operate in the evacuation state and initiates the purge state, although other time periods are contemplated for use in the system 100 of the present application. It is noted that an average time period of 30-45 seconds was found in a working embodiment to reduce the tank pressure from about +0.2 inches of water to about −1.0 inches of water. This arrangement, which uses a maximum predetermined amount of time for operation of the evacuation state, can be used to prevent the adsorbent material in the canister 102 from being over-filled with adsorbed vapor.

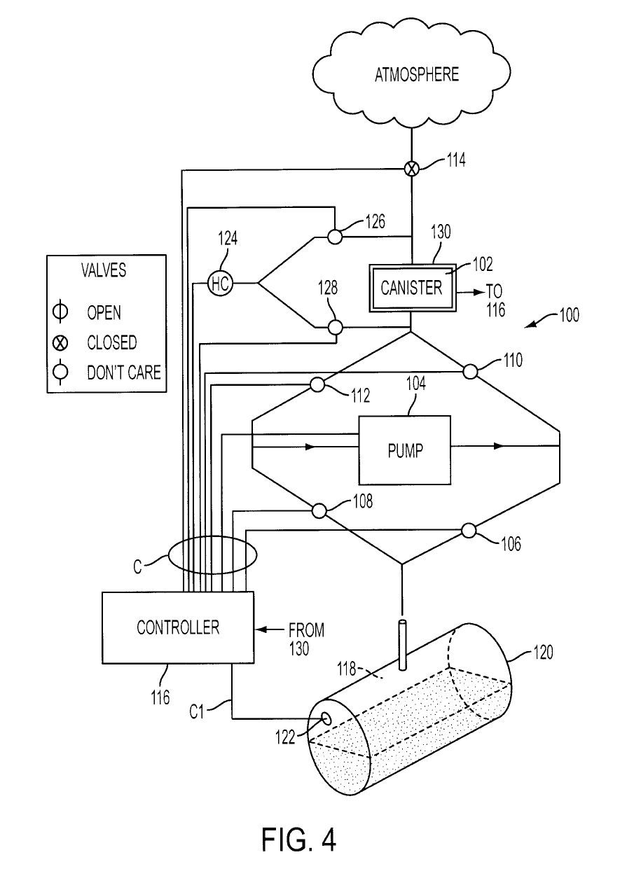

In another control arrangement for the system 100, a sensor, such as a hydrocarbon (HC) sensor 124, may be used to monitor the output from the canister 102 to determine the condition of the adsorbent material in the canister 102, see FIG. 4. One possible choice of a number of HC sensors that are commercially available is a PIRVOL-V4 HC sensor (part # 007129-001) available from DET-TRONICS. During operation of the system 100 in the evacuation state, air evacuated from the canister 102 to the atmosphere has a HC content of about 2% or less, provided that the condition of the adsorbent material in the canister 102 is not nearing saturation and the material is properly performing the function of adsorbing gasoline vapor. When the adsorbent material in the canister 102 approaches its maximum vapor adsorption capacity, the HC content of the air output increases to a level above about 2%. Accordingly, evacuation operating states of the system 100 can be terminated when sensed levels of HC in the non-polluting output to atmosphere exceeds a predefined level above about 2%. For example, a level of 5% could be used for termination of evacuation states.

The detection of non-pollutant output to the atmosphere from the canister 102 having a first level of hydrocarbons, above about 2% HC content, can be used to both deactivate evacuation states of the system 100 and also to activate purge states of the system 100 to prepare the system 100 for operation in its next evacuation state. In addition, the HC sensor 124 can be used to terminate purge states of the system 100 when the detection of hydrocarbons in output from the canister 102 to the tank 120 goes below a second level of hydrocarbons. For deactivation of evacuation states and/or activation of purge states, the output of the canister to atmosphere must be monitored by the HC sensor. For deactivation of purge states, the output of the canister 102 to the tank 120 must be monitored by the HC sensor 124. To enable use of a single HC sensor 124, a pair of single acting valves 126, 128 can be used to connect the canister 102 to the HC sensor 124, see FIG. 4. While the valves 126, 128 are schematically illustrated as single acting valves, a three way valve may be used or the valves 126, 128 can be incorporated into an integral valve manifold or other valving arrangements that will perform the described fluid valving required for operation of the HC sensor 124 can be used.

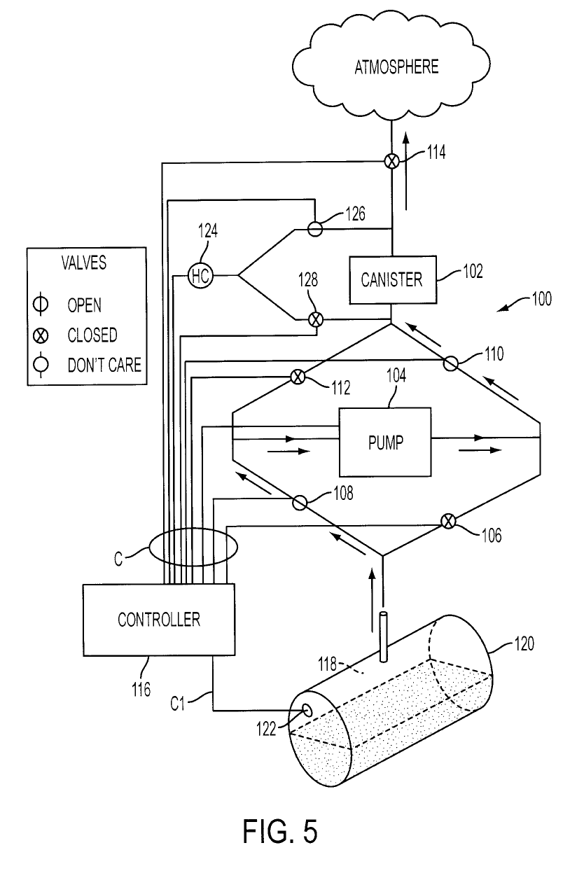

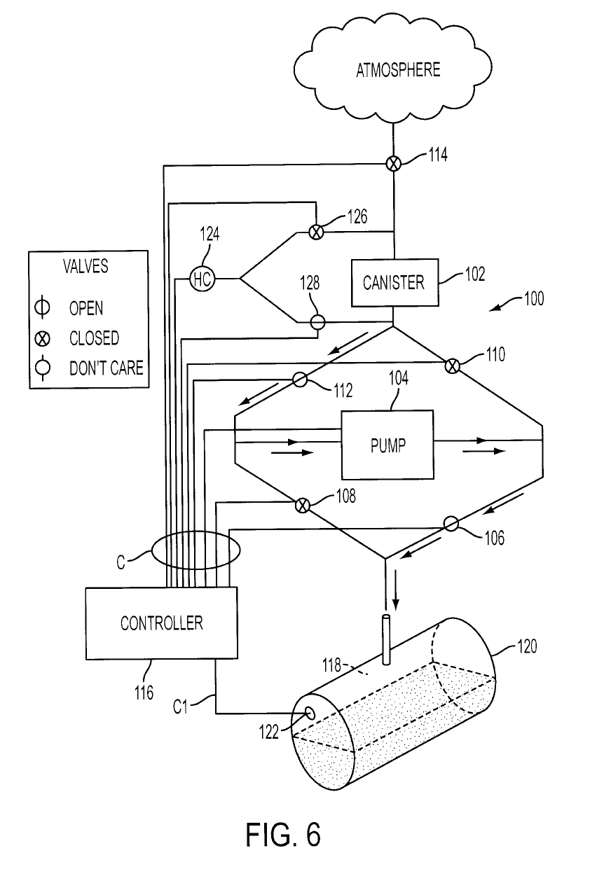

As shown in FIG. 4, the system 100 is inactive. With regard to the valves 106-114 for evacuation and purge operating states, operation is as described above with reference to FIGS. 1-3. With regard to the HC sensor 124, for operation of the system 100 in the evacuation state, the valve 128 is closed and the valve 126 is open so that the output of the canister 102 connected to atmosphere is also connected to the HC sensor 124, see FIG. 5. For operation of the system 100 in the purge state, the states of the valves 126, 128 are reversed, i.e., the valve 126 is closed and the valve 128 is open so that the HC sensor 124 is connected to monitor the output of the canister 102 connected to the tank 120 is also connected to the HC sensor 124, see FIG. 6.

As described above with reference to FIG. 6, during purge operating states of the system 100, operation of the pump 104 pulls a vacuum on the adsorbent material in the canister 102 resulting in gasoline vapor that has been adsorbed being removed, de-adsorbed or purged from the adsorbent material and returned to the storage tank 120. While termination of evacuating operating states of the system 100 can be triggered by increased HC levels in non-pollutant output to the atmosphere, termination of purging states of the system 100 can be triggered by decreased HC levels in output from the canister 102 to the storage tank 120. Thus, signals from the HC sensor 124 can be used to determine both when to active purge operating states and when to terminate purge operating states of the system 100. For example, a level of 2% or less could be used for termination of evacuation states.

In a further control arrangement, the weight of the canister 102 (or the adsorbent material therein) could be monitored during operation in the evacuation state, such as, for example, by a load cell 130 which could be incorporated into the canister 102 or into its supporting structure as shown in FIG. 4. The weight of the canister 102 could be used to determine the amount of time to operate the system 100 in the evacuation state, as the weight of the adsorbent material increases as the adsorbent material adsorbs gasoline vapor. To implement this arrangement, the known weight of a canister including adsorbent material at full vapor capacity could be compared to the weight of the canister 102 including adsorbent material during active operation of the system 100. Once the weight of the canister 102 reaches a first predetermined level, which may be, for example, the weight of the canister including the adsorbent material at full vapor capacity or slightly less, the system 100 may cease operation in the evacuation state and initiate operation in the purge state. The purge state could then be operated until the weight of the canister 102 reaches a second predetermined level, the second predetermined level being less that the first and may be, for example, the weight of the canister 102 and a known weight of the adsorbent material with substantially no adsorbed vapor.

It is understood that several of the above control arrangements could be combined to define a desired control scheme for operating the system 100. In the system 100 shown in FIG. 4, combinations of tank pressure, HC content, and weight of the canister including adsorbent material could be used.

Where the system 100 is partially controlled by another controller, such as when the controller 116′ of a gasoline distribution facility (GDF) is used to send signals corresponding to tank pressure, the dedicated controller of the system 100 uses the tank pressure signals to effectively operate the system 100. An example of operation of the system 100 with an existing system will be briefly described relative to a Pressure Management Control/In Station Diagnostics (PMC/ISD) system commercially available from the Veeder-Root Company. This system currently operates with an Emission Control System (ECS) available from Vapor Systems Technologies, Inc., the assignees of the present application. When operating with the ECS, the PMC/ISD sends an on signal and an off signal to the ECS. These signals can be used by the system 100 with the aid of a dedicated controller to operate the system 100 by activating the system 100 to operate in the evacuation state in response to the on signal and operating the system 100 in the purge state in response to the off signal. By operating in response to signals currently provided by the PMC/ISD, the system 100 of the present application can be conveniently retrofitted into existing GDFs and also can be used in new installations with no change required for the PMC/ISD.

There are several advantages of the active adsorbent pollutant reducing system 100 of the present application over known passive adsorbent systems. Initially, the system 100 can be cycled indefinitely as needed to control the UST pressure, so it does not have the capacity constraints of a passive system. Further, the system 100 does not rely on the functions of other variables at the GDF, such as the vapor recover system or system leakage, to function correctly. Also, the system 100 does not allow air to be ingested as part of system operation, but the passive system does allow air to be ingested and in fact relies on the ingestion of air which is counter-productive to the goals of systems for reducing the discharge of pollutants from gasoline storage tanks. Furthermore, the size of the system 100 is substantially reduced in comparison to corresponding passive systems.

With regard to size, most USTs are between 10 K gallons and 15 K gallons, and there are anywhere from two to four USTs at a GDF or gasoline station. Based on test data, it is estimated that a passive adsorption system using activated carbon would have to be able to adsorb approximately seven pounds of gasoline. For that capacity, the adsorption canister would have to have about twenty four (24) pounds of activated carbon to be able to meet these demands. Accordingly, the canister size would have to be around six (6) inches in diameter and forty eight (48) inches long. Comparably, the active system 100 of the present application would require only about five and three quarter (5¾) pounds of activated carbon so that the canister 102 would only be about five (5) inches in diameter and about eighteen (17) inches long. Accordingly, the canister 102 of the system 100 can be substantially smaller in size than that required by a passive system.

Having thus described the invention of the present application in detail and by reference to embodiments thereof, it will be apparent that modifications and variations are possible without departing from the scope of the invention defined in the appended claims.

What is claimed is:

1. An active adsorbent pollutant reducing system comprising:
an adsorbent material disposed in a containing structure, said adsorbent material adapted to adsorb vapor from a gaseous mixture comprising at least said vapor and a non-pollutant gas;
a pump for pumping said gaseous mixture; and
a valve system comprising a series of valves that are in communication with said containing structure, said pump and a fuel storage tank;
said valve system and said pump being configured according to a first state wherein said pump pumps said gaseous mixture from said tank into said containing structure such that said adsorbent material adsorbs at least a portion of said vapor from said gaseous mixture, and at least a portion of said non-pollutant gas is discharged as an output of said containing structure to atmosphere; and
said valve system and said pump being configured according to a second state wherein said pump pulls a vacuum on said adsorbent material disposed in said containing structure to remove at least a portion of said adsorbed vapor from said adsorbent material and return at least a portion of said removed adsorbed vapor as an output of said containing structure to said tank.

2. The pollutant reducing system according to claim 1, further comprising a controller in communication with said pump and said valve system that configures said pump and said valve system into said first and second states.

3. The pollutant reducing system according to claim 2, further comprising a pressure sensor that monitors pressure in said tank, said pressure sensor being in communication with said controller for indicating said pressure within said tank to said controller wherein when pressure within said tank reaches a first level, said valve system and said pump are configured into said first state and when a pressure within said tank reaches a second level that is lower than said first level, said valve system and said pump are configured into said second state.

4. The pollutant reducing system according to claim 2, further comprising a hydrocarbon sensor used to determine the condition of said adsorbent material disposed in said containing structure and said valve system is further connected to said hydrocarbon sensor, wherein said valve system can be configured to monitor hydrocarbons in said output of said containing structure discharged to atmosphere during operation of said system in said first state and can be configured to monitor said output of said containing structure to said tank during operation of said system in said second state.

5. The pollutant reducing system according to claim 4, wherein said controller terminates said first state when a first level of hydrocarbons is detected in said output of said containing structure discharged to atmosphere during operation of said system in said first state and terminates said second state when a second level of hydrocarbons is detected in said output of said containing structure to said tank during operation of said system in said second state.

6. The pollutant reducing system according to claim 1, wherein said pump pumps said removed adsorbed vapor from said containing structure back into said tank.

7. The pollutant reducing system according to claim 3, wherein said pump continues to pump said gaseous mixture into said containing structure until said pressure within said tank reaches said second level.

8. The pollutant reducing system according to claim 1, wherein said first and second states comprise an active portion of an operating cycle of said system and wherein said valve system and said pump are configured according to a third state during which said pump is turned off and communication between said containing structure and atmosphere is substantially blocked by said valve system, said third state comprising an inactive portion of said operating cycle of said system.

9. The pollutant reducing system according to claim 1, wherein said second state is maintained for a sufficient period of time so that substantially all of said adsorbed vapor is removed from said adsorbent material.

10. The pollutant reducing system according to claim 1, wherein said second state is maintained for a sufficient period of time such that an adequate amount of said adsorbed vapor is removed from said adsorbent material such that said adsorbent material disposed in said containing structure is capable of adsorbing fuel vapor from said gaseous mixture during a subsequent first state operating cycle.

11. The pollutant reducing system according to claim 1, further comprising a restrictor associated with an outlet end of said containing structure for increasing a pressure within said containing structure.

12. The pollutant reducing system according to claim 1, further comprising a thermal device for adding heat to said containing structure to improve purging by increasing the rate of vapor removal from said adsorbent material during said second state.

13. A method of operating an active adsorbent pollutant reducing system to reduce pollutant discharged from a fuel storage tank comprising:
during a first operating state of said system:
pumping a gaseous mixture of fuel vapor and air to adsorbent material contained with a containing structure;
adsorbing vapor contained in said gaseous mixture in said adsorbent material;
discharging a gaseous mixture from said containing structure to atmosphere; and
during a second operating state of said system:
pumping a gaseous mixture of adsorbed vapor and air from said containing structure to return at least a portion of said removed vapor to said tank.

14. A method according to claim 13 further comprising:
monitoring pressure in said fuel storage tank;
activating said first operating state in response to pressure of a first level in said fuel storage tank; and
in response to pressure in said fuel storage tank of a second level lower than said first level, deactivating said first operating state and activating said second operating state.

15. A method according to claim 13 further comprising:
monitoring hydrocarbon content of said gaseous mixture discharged from said containing structure to atmosphere;
deactivating said first operating state and activating said second operating state if the hydrocarbon content of said gaseous mixture discharged to atmosphere reaches a first level of hydrocarbons;
monitoring hydrocarbon content of said gaseous mixture pumped from said containing structure to said tank; and
deactivating said second operating state if the hydrocarbon content of said gaseous mixture pumped to said tank reaches a second level of hydrocarbons.

16. A method according to claim 13 further comprising:
monitoring pressure in said fuel storage tank;
activating said first operating state in response to pressure of a first level in said fuel storage tank;
deactivating said first operating state after a predefined evacuation period of time;
activating said second operating state; and
deactivating said second operating state after a predefined purge period of time.

17. A method according to claim 13 further comprising providing a valve system so that a single pump can pump a gaseous mixture to and from said containing structure.

18. A method according to claim 15 further comprising providing a valve system so that a single hydrocarbon sensor can be used for monitoring hydrocarbon content of said gaseous mixture discharged to atmosphere and for monitoring hydrocarbon content of said gaseous mixture pumped to said tank.

19. The method according to claim 13, wherein pumping a gaseous mixture of adsorbed vapor and air from said containing structure to return at least a portion of said removed vapor to said tank is performed for a period sufficient such that substantially all adsorbed vapor is removed from said adsorbent material.

20. The method according to claim 13, wherein pumping a gaseous mixture of adsorbed vapor and air from said containing structure to return at least a portion of said removed vapor to said tank is performed for a period of time sufficient so that an adequate amount of the adsorbed vapor is removed from said adsorbent material so that the adsorbent material in the containing structure is capable of adsorbing fuel vapor during a subsequent first operating state.
